(19) United States
(12) Patent Application Publication
(10) Pub. No.: US 2012/0156923 A1
(43) Pub. Date: Jun. 21, 2012

(54) CONNECTION LINE

(75) Inventor: FENG GAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/981,488

(22) Filed: Dec. 30, 2010

(30) Foreign Application Priority Data
Dec. 15, 2010 (CN) 201010589770.6

(51) Int. Cl. H01R 3/00

(52) U.S. Cl. 439/488

(57) ABSTRACT

A connection line includes a first plug connected to an electronic device, a second plug connected to a socket, a cable connected between the first plug and the second plug, a first light-emitting diode (LED), a switch, and a second LED. A cathode of the first LED is connected to a ground terminal of the cable. An anode of the second LED is connected to a power terminal of the cable. A cathode of the second LED is connected to an anode of the first LED through the switch. The first LED and the switch are located on the cable and near the first plug. The second LED is located on the cable and near the second plug.

### BACKGROUND

1. Technical Field

The present disclosure relates to a connection line.

2. Description of Related Art

Generally, more than one electronic devices are plugged into a multi-socket electrical outlet. As a result, connection lines of the electronic devices may be twisted together. Therefore, when users want to unplug one of the electronic devices, the users may make a mistake. A conventional method to identify the plugs is to have two same labels on two ends of each connection line. However, the labels on the connection line may be lost easily.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a circuit diagram of a first embodiment of a connection line connected to an electronic device.

FIG. 2 is circuit diagram of a second embodiment of a connection line connected to an electronic device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

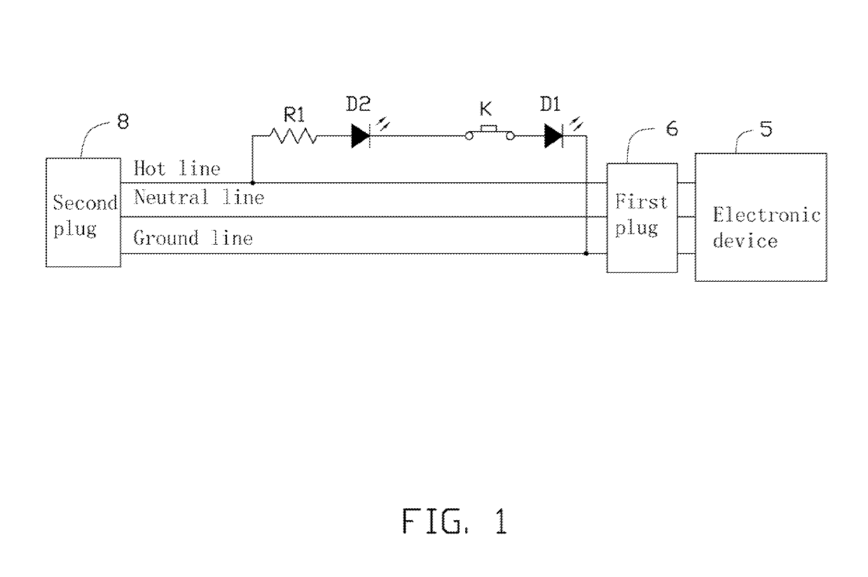

Referring to FIG. 1, a first embodiment of a connection line includes a cable, a first plug 6, a second plug 8, a resistor R1, a first light light-emitting diode (LED) D1, a second LED D2, and a switch K.

In this first embodiment, the connection line is a power line. The cable of the power line includes a hot wire, a neutral line, and a ground line. The cable is connected between the first plug 6 and the second plug 8. The first plug 6 is connected to an electronic device 5. The second plug 8 is configured to be connected to a socket for supplying power to the electronic device 5.

A cathode of the first LED D1 is connected to the ground line. An anode of the first LED D1 is connected to a cathode of the second LED D2 through the switch K. An anode of the second LED D2 is connected to the hot line through the resistor R1. The first LED D1 and switch K are located on the cable and near the first plug 6. The second LED D2 is located on the cable and near the second plug 8.

As a result, when the electronic device 5 needs to be powered off, the switch K near the first plug 6 connected to the electronic device 5 is pressed. Therefore, the first LED D1 and the second LED D2 light, thus to identify the second plug 8. The second plug 8 identified is unplug to power off the electronic device 5.

In other embodiments, the connection line may be other lines, such as data lines. A first terminal of the resistor R1 is connected to a power terminal of the data line. The cathode of the first LED D1 is connected to a ground terminal of the data line. Moreover, if the connection line has a low voltage, the resistor R1 can be omitted.

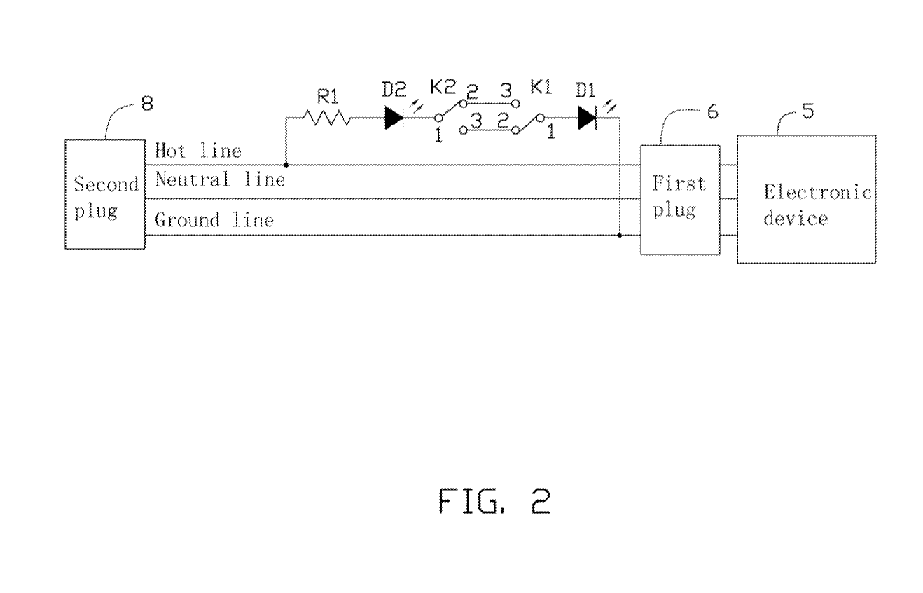

Referring to FIG. 2, in a second embodiment of a connection line, a two wire switch replaces the switch K in the first embodiment of the connection line. The two wire switch includes a first single-pole double-throw (SPDT) switch K1 and a second SPDT switch K2. Each of the first SPDT switch K1 and the second SPDT switch K2 includes first to third terminals. A first terminal 1 of the first SPDT switch K1 is connected to the anode of the first LED D1. A second terminal 2 of the first SPDT switch K1 is connected to a third terminal 3 of the second SPDT switch K2. A third terminal 3 of the first SPDT switch K1 is connected to a second terminal 2 of the second SPDT switch K2. A first terminal 1 of the second SPDT switch K2 is connected to the cathode of the second LED D2. The first LED D1 and the first SPDT switch K1 are located on the cable and near the first plug 6. The second LED D2 and the second SPDT switch K2 are located on the cable and near the second plug 8.

As a result, when the electronic device 5 needs to be powered off, the first SPDT switch K1 near the first plug 6 connected to the electronic device 5 or the second SPDT switch K2 is pressed. Therefore, the first LED D1 and the second LED D2 light, thus to identify the second plug 8 of the power line. The second plug 8 identified is unplug to power off the electronic device 5.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A connection line comprising:
a first plug to be connected to an electronic device;
a second plug to be connected to a socket;
a cable connected between the first plug and the second plug;
a first light-emitting diode (LED), wherein a cathode of the first LED is connected to a ground terminal of the cable;
a switch, wherein the first LED and the switch are located on the cable and near the first plug; and
a second LED, wherein an anode of the second LED is connected to a power terminal of the cable, a cathode of the second LED is connected to an anode of the first LED through the switch, the second LED is located on the cable and near the second plug.

2. The connection line of claim 1, further comprising a resistor, wherein the resistor is connected between the power terminal of the connection line and the anode of the second LED.

3. The connection line of claim 1, wherein the connection line is a power line, a hot line of the power line is the power terminal of the cable, a ground line of the power line is the ground terminal of the cable.

4. A connection line comprising:
a first plug to be connected to an electronic device;
a second plug to be connected to a socket;
a cable connected between the first plug and the second plug;
a first light-emitting diode (LED), wherein a cathode of the first LED is connected to a ground terminal of the cable;
a second LED, wherein an anode of the second LED is connected to a power terminal of the cable; and
a two wire switch comprising a first single-pole double-throw (SPDT) switch and a second SPDT switch, wherein a first terminal of the first SPDT switch is connected to an anode of the first LED, a second terminal of the first SPDT switch is connected to a third terminal of the second SPDT switch, a third terminal of the first SPDT switch is connected to a second terminal of the second SPDT switch, a first terminal of the second SPDT is connected to a cathode of the second LED; wherein the first LED and the first SPDT switch are located on the cable and near the second plug, the second LED and the second SPDT are located on the cable and near the second plug.

5. The connection line of claim 4, further comprising a resistor, wherein the resistor is connected between the power terminal of the connection line and the anode of the second LED.

6. The connection line of claim 4, wherein the connection line is a power line, a hot line of the power line is the power terminal of the cable, a ground line of the power line is the ground terminal of the cable.
